(19) United States
(12) Patent Application Publication
(10) Pub. No.: US 2025/0253483 A1
(43) Pub. Date: Aug. 7, 2025

(54) BATTERY PACK VENTING ASSEMBLY AND VENTING METHOD

(71) Applicant: Ford Global Technologies, LLC, Dearborn, MI (US)

(72) Inventor: Xiaogang Zhang, Novi, MI (US)

(21) Appl. No.: 18/435,443

(22) Filed: Feb. 7, 2024

(51) Int. Cl. H01M 50/367; H01M 50/204; H01M 50/249; H01M 50/333

(52) U.S. Cl. CPC H01M 50/367; H01M 50/333; H01M 50/204; H01M 50/249; H01M 2200/20; H01M 2220/20

(57) ABSTRACT

A method of venting a traction battery pack includes providing a manifold system that fluidly couples a plurality of battery modules to a battery pack vent. Each of the battery modules has a cell stack. The manifold system communicates vent byproducts discharged from each cell stack along a first path to the battery pack vent and further communicates vent byproducts discharged from each cell stack along a second path to the battery pack vent. When a cell stack is discharging a flow of vent byproducts, the method directs a first percent of the flow through the manifold system along the first path to a battery pack vent, and directs a second percent of the flow through the manifold system along the second path to the battery pack vent. The method then includes exhausting the first percent and the second percent through the battery pack vent.

### TECHNICAL FIELD

This disclosure relates generally to exhausting vent byproducts from a traction battery pack.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

### SUMMARY

In some aspects, the techniques described herein relate to a method of venting a traction battery pack, including: providing a manifold system that fluidly couples a plurality of battery modules to a battery pack vent, each of the battery modules having an associated cell stack, the manifold system configured to communicate vent byproducts discharged from each cell stack along a first path to the battery pack vent and further configured to communicate vent byproducts discharged from each cell stack along a second path to the battery pack vent; when a cell stack is discharging a flow of vent byproducts, directing a first percent of the flow through the manifold system along the first path to a battery pack vent, and directing a second percent of the flow through the manifold system along the second path to the battery pack vent; and exhausting the first percent and the second percent through the battery pack vent.

In some aspects, the techniques described herein relate to a method, further including moving a relief valve assembly from a closed position to an open position to permit the first percent of the flow of vent byproducts to move to the first path and the second percent of the flow of vent byproducts to move to the second path, the first percent and the second percent dependent on the open position of the relief valve assembly.

In some aspects, the techniques described herein relate to a method, wherein the traction battery pack includes a plurality of flow diverters, each flow diverter within the plurality of flow diverters associated with one of the battery modules within the plurality of battery modules, each flow diverter dividing the flow of vent byproducts from the associated cell stack into the first percent and the second percent, wherein the flow diverters within the plurality of flow diverters divide the flow of vent byproducts differently from each other depending on an amount of time the flow of vent byproducts is contained within the manifold system when communicating along the first path to the battery pack vent compared to an amount of time the flow of vent byproducts is contained within the manifold system when communicating along the second path.

In some aspects, the techniques described herein relate to a method, wherein the first percent of the flow of vent byproducts is contained within the manifold system for a first amount of time when communicated to the battery pack vent along the first path, and the second percent of the flow of vent byproducts is contained within the manifold system for a second amount of time when communicated to the battery pack vent along the second path, the first amount of time more than the second amount of time.

In some aspects, the techniques described herein relate to a method, wherein the first amount of time and the second amount of time associated with exhausting vent byproducts from a first cell stack through the battery pack vent are further apart than the first amount of time and the second amount of time associated with exhausting vent byproducts from a second cell stack through the battery pack vent, wherein the flow diverter that is associated with second cell stack more evenly divides into the first percent and the second percent than the flow diverter that is associated with the first cell stack.

In some aspects, the techniques described herein relate to a method, wherein the first path from a first module having the first cell stack to the battery pack vent is a longer path than the second path from the first module to the battery pack vent.

In some aspects, the techniques described herein relate to a method, wherein the plurality of flow diverters are a plurality of relief valve assemblies that move to an open position to permit discharging of the flow of vent byproducts from associated cell stack into the manifold system.

In some aspects, the techniques described herein relate to a method, wherein the relief valve assemblies within the plurality of relief valve assemblies each include a spring, and further including adjusting the first percent and the second percent for each of the relief valve assemblies varying a biasing force for the spring.

In some aspects, the techniques described herein relate to a traction battery venting system, including: a battery pack vent; a first battery module having a first cell stack; a second battery module having a second cell stack; a manifold system that fluidly couples the first and second battery modules to the battery pack vent; a first diverter configured to divert vent byproducts discharged from the first cell stack into the manifold system, the first diverter directing a first percent of the vent byproducts discharged from the first cell stack into the manifold system to flow along a first path to the battery pack vent, the first diverter directing a second percent of the vent byproducts discharged from the first cell stack into the manifold system to flow along a different, second path to the battery pack vent; and a second diverter configured to divert vent byproducts discharged from the second cell stack into the manifold system, the second diverter directing a first percent of the vent byproducts discharged from the second cell stack into the manifold system to flow along the first path to the battery pack vent, the second diverter directing a second percent of the vent byproducts discharged from the second cell stack into the manifold system to flow along a different, second path to the battery pack vent.

In some aspects, the techniques described herein relate to a traction battery venting system, wherein the first diverter is configured to direct more flow to the first path than to the second path.

In some aspects, the techniques described herein relate to a traction battery venting system, wherein the first diverter is configured to direct more flow to the first path than the second diverter.

In some aspects, the techniques described herein relate to a traction battery venting system, wherein first diverter is a first valve assembly having a first spring and the second diverter is a second valve assembly having a second spring, wherein a spring rate of the first spring is different than a spring rate of the second spring to make an open position of the first valve assembly different that an open position of the second valve assembly.

In some aspects, the techniques described herein relate to a traction battery venting system, including: a plurality of battery modules each having at least one cell stack; a battery pack vent; and a manifold system that fluidly couples the battery modules to the battery pack vent, the manifold system configured to communicate a first percent of vent byproducts discharged from one of the cell stacks to the battery pack vent along a first path and to communicate a second percent of the vent byproducts discharged from the one of the cell stacks to the battery pack vent along a second path, the first path longer than the second path.

In some aspects, the techniques described herein relate to a traction battery venting system, further including a diverter system having a plurality of diverters, each diverter within the plurality of diverters associated with one of the cell stacks within the plurality of cell stacks, each diverter within the plurality of diverters configured to direct more flow of the vent byproducts to the first path than the second path.

In some aspects, the techniques described herein relate to a traction battery venting system, wherein the plurality of diverters include a plurality of relief valve assemblies that transition to an open position in response to a pressure differential.

In some aspects, the techniques described herein relate to a traction battery venting system, wherein the plurality of relief valve assemblies each include a biasing member having a biasing force that controls the open position, wherein the biasing force among the plurality of relief valve assemblies is varied to cause some of the relief valve assemblies to direct more flow to the first path when in an open position that other relief valve assemblies in the open position.

In some aspects, the techniques described herein relate to a traction battery venting system, wherein the relief valve assemblies are configured to open to permit the vent byproducts to move from the respective cell stacks to the manifold system, and the relief valve assemblies are configured to open different amounts to direct more flow of the vent byproducts to the first path.

In some aspects, the techniques described herein relate to a traction battery venting system, wherein the manifold system circumscribes the plurality of battery modules.

In some aspects, the techniques described herein relate to a traction battery venting system, wherein each of the cell stacks within the plurality of cell stacks is held within a module enclosure assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective and partially expanded view of a battery pack according to an exemplary aspect of the present disclosure.

FIG. 3 illustrates a schematic top view of the battery pack of FIG. 2 when a battery cell of a cell stack is discharging a flow of vent byproducts.

FIG. 4 illustrates a schematic top view of the battery pack of FIG. 2 when another battery cell of another cell stack is discharging a flow of vent byproducts.

FIG. 5 illustrates a close-up view of an area of FIG. 3.

FIG. 6 illustrates a close-up view of an area of FIG. 4.

### DETAILED DESCRIPTION

This disclosure relates generally to a traction battery pack for an electrified vehicle and, in particular, to discharging vent byproducts from the traction battery pack.

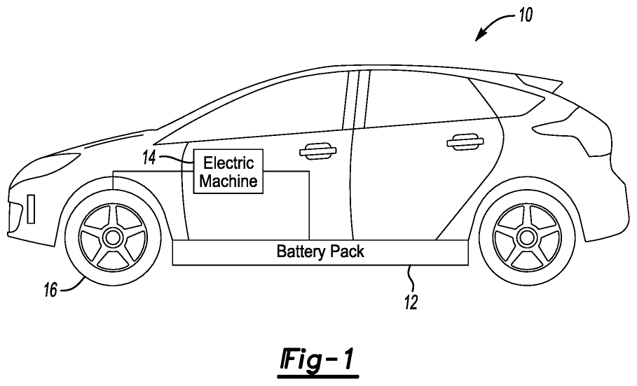

With reference to FIG. 1, an electrified vehicle 10 includes a traction battery pack 12, an electric machine 14, and wheels 16. The battery pack 12 powers the electric machine 14, which can convert electric power to torque to drive the wheels 16. The battery pack 12 is a traction battery pack as the battery pack 12 is used for propulsion.

The battery pack 12 is, in the exemplary embodiment, secured to an underbody of the electrified vehicle 10. The battery pack 12 could be located elsewhere on the electrified vehicle 10 in other examples.

The example vehicle 10 is a battery electric vehicle (BEV). In another example, the vehicle 10 could be another type of electrified vehicle, such as a hybrid electric vehicle (HEV), plug-in hybrid electric vehicle (PHEV), or a conventional vehicle. A hybrid electric vehicle selectively drives wheels using torque provided by an internal combustion engine instead of, or in addition to, an electric machine. Generally, the electrified vehicle 10 could be any type of vehicle having a traction battery pack.

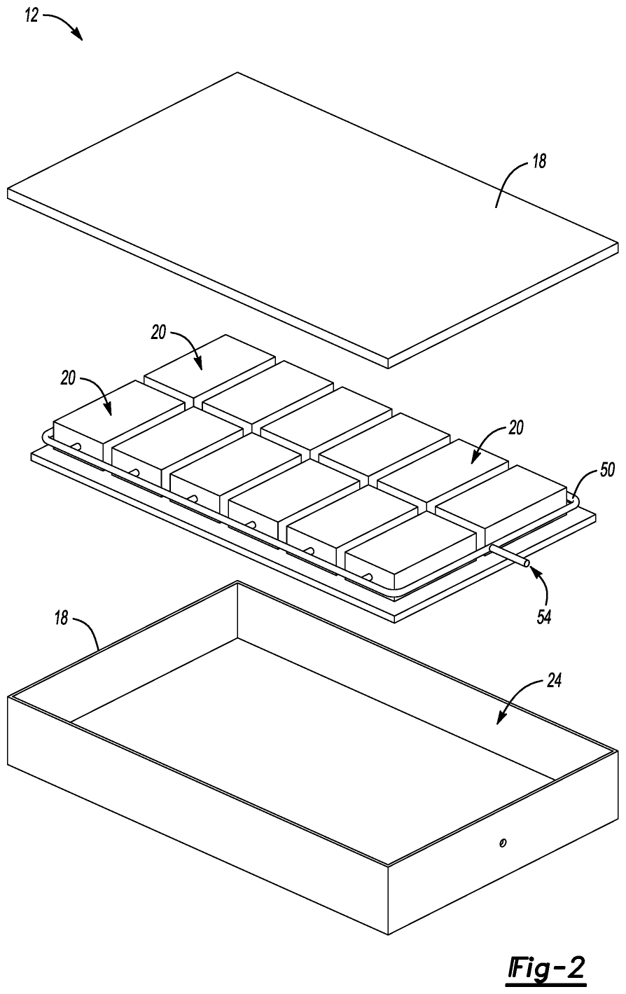

Referring now to FIGS. 2-4, the battery pack 12 includes a battery pack enclosure assembly 18 and a plurality of battery modules 20 that are housed within an interior 24 of the battery pack enclosure assembly 18. Each of the battery modules 20 includes a module enclosure assembly 32 and a cell stack 36 that is housed within the module enclosure assembly. The cell stack 36 includes a plurality of individual battery cells 40.

In this example, each of the module enclosure assemblies 32 houses a single cell stack 36. In other examples, the module enclosure assemblies 32 could hold more than one cell stack 36.

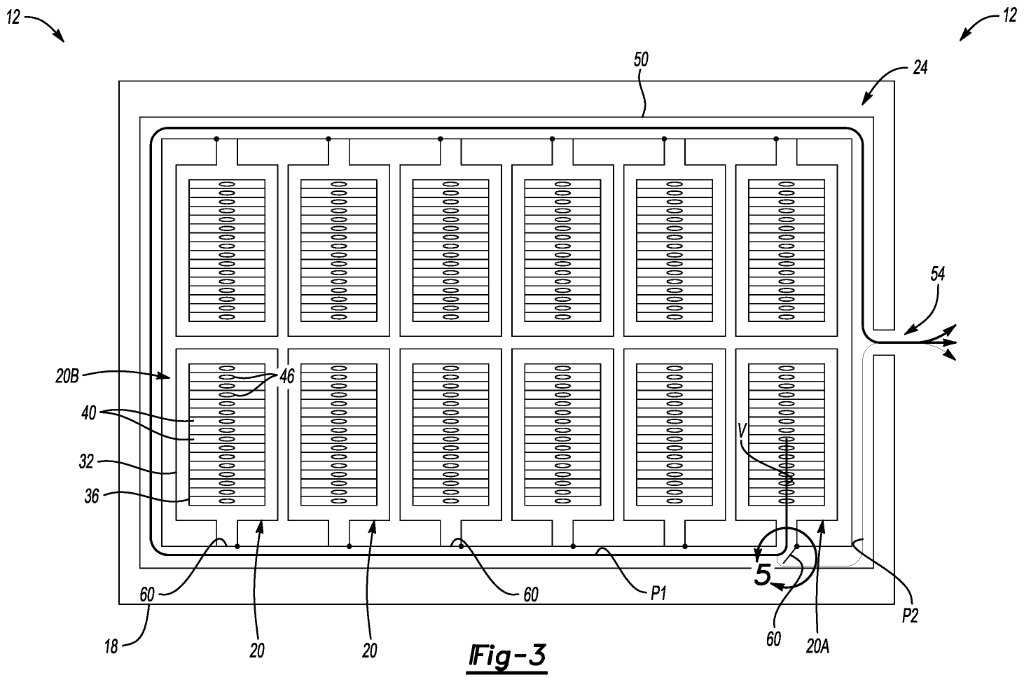

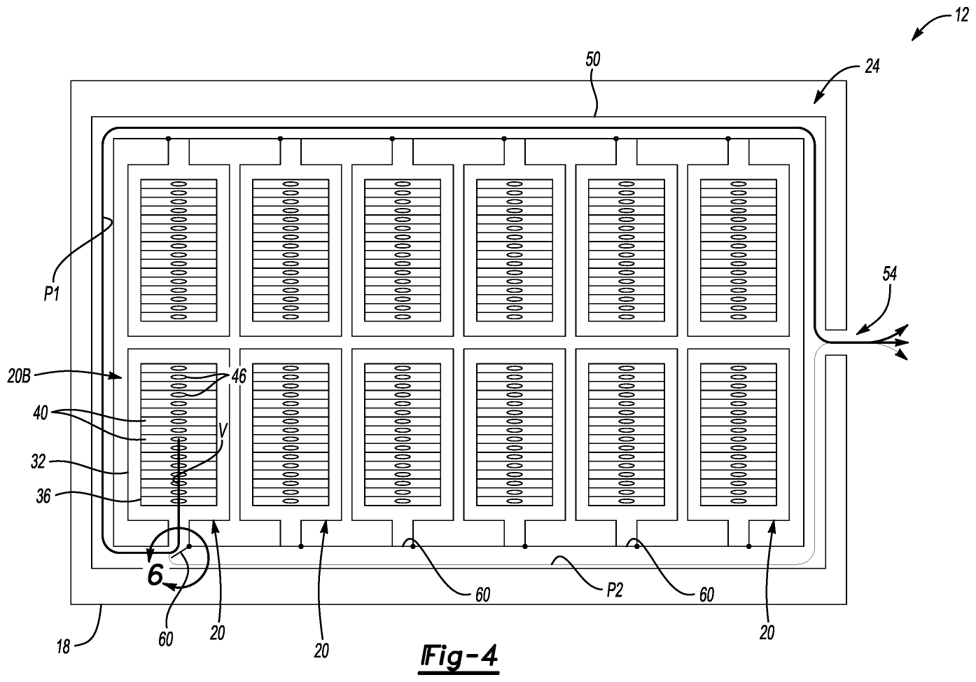

From time to time, pressure and thermal energy within at least one of the battery cells 40 in the cells stacks 36 of the battery pack 12 can increase. This can lead to the battery cell 40 discharging a flow of vent byproducts V, which can include gas and debris. FIG. 3 illustrates one of the battery cells 40 in one of the battery module 20A discharging a flow of vent byproducts V. FIG. 4 illustrates one of the battery cells 40 in another of the battery modules 20B discharging a flow of vent byproducts V.

The vent byproducts V can be discharged from the battery cell 40 through a designated cell vent 46 within a housing of the battery cell 40. The cell vent 46 can be a membrane that yields in response to increased pressure and thermal energy within the battery cell 40. The cell vent 46 can also be a ruptured area of the associated battery cell 40.

The battery pack 12 further includes a manifold system 50 and a battery pack vent 54. In this example, the manifold system 50 connects to each of the module enclosure assemblies 32 to fluidly couple each of the battery modules 20 to the battery pack vent 54. As required, the manifold system 50 can communicate a flow of vent byproducts V discharged from the one or more battery cells 40 within the cell stacks 36 to the battery pack vent 54. At the battery pack vent 54, the flow of vent byproducts V is exhausted from the battery pack 12 to an area surrounding the battery pack vent 54. In this example, the manifold system 50 circumscribes the plurality of battery modules 20. All twelve of the module enclosure assemblies 32 can vent to the manifold system 50.

In this example, after the vent byproducts V pass through the cell vent 46, the vent byproducts V are initially contained within an interior of the module enclosure assembly 32. The vent byproducts V can then flow to the manifold system 50.

The manifold system 50 is configured to communicate the vent byproducts V along a respective first path P1 to the battery pack vent 54 or along a respective second path P2 to the battery pack vent 54. The first path is longer than the second path in this example. In such the example, the vent byproducts V communicated to the battery pack vent 54 along the first path would remain within the manifold system 50 longer than the vent byproducts V communicated to the battery pack vent 54 along the second path.

In this example, each battery module 20 has its own first path P1 and its own second path P2. The lengths of the first paths P1 and second paths P2 depend, in this example, on where the battery module 20 opens to the manifold system 50 relative to a location of the battery pack vent 54. In FIG. 3, a first difference is a difference between a length of the first path P1 from the battery module 20A and a length of the second path P2 from the battery module 20A. In FIG. 4, a second difference is a difference between a length of the first path P1 from the battery module 20B and a length of the second path P2 from the battery module 20B. The first difference is greater than the second difference.

Thermal energy within the flow of vent byproducts V dissipates as the flow of vent byproducts V is communicated through the manifold system 50. Regarding the battery modules 20A and 20B, as the vent byproducts V communicated to the battery pack vent 54 along the first paths P1 remain in the manifold system 50 longer than the vent byproducts V communicated to the battery pack vent 54 along the second paths P2, the vent byproducts V discharged from the battery pack vent 54 after communicating along the first path P1 contain less thermal energy than the vent byproducts V discharged from the battery pack vent 54 after communicating along the second path P2.

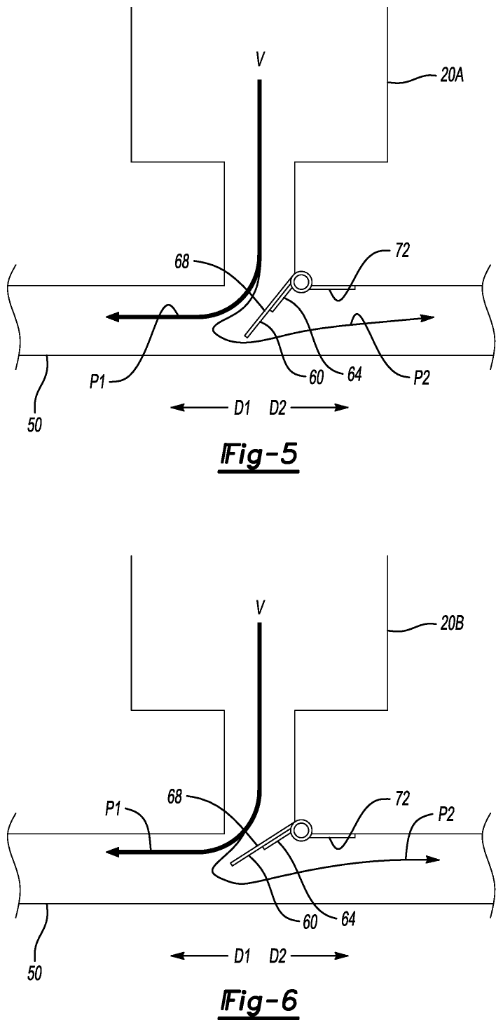

With reference now to FIGS. 5 and 6 and continuing reference to 2-4, the example battery pack 12 includes a plurality of flow diverters 60, which, in this example, are relief valve assemblies 64. One relief valve assembly 64 is associated with each battery module 20. The relief valve assembly 64 can transition between a closed position and an open position. The relieve valve assembly 64 is ordinarily closed but, in this example, transitions to the open position in response to a pressure differential cause by an increase in pressure within the module enclosure assembly 32 of the respective battery module 20.

In the closed position, the relief valve assembly 64 blocks flow between the manifold system 50 and the module enclosure assembly 32. This stops vent byproducts V discharged into the manifold system 50 from battery cells 40 within one of the battery modules 20 from flowing into the module enclosure assembly 32 of another of the battery modules 20.

In the open position, the relief valve assembly 64 permits the flow of vent byproducts V discharged from battery cells 40 of the associated battery module 20 into the manifold system 50. The relief valve assembly 64 can open in response to a pressure increase within the associated battery module 20 where the pressure increase is due to one or more of the battery cells 40 of the associated battery module 20 discharging the flow of vent byproducts V into the module enclosure assembly 32.

In this example, the relief valve assembly 64 in the open position diverts flow by directing a first percent of the flow of vent byproducts V through the manifold system 50 along the first path to the battery pack vent 54, and by directing a second percent of the flow of vent byproducts through the manifold system 50 along the second path to the battery pack vent 54. Each of the relief valve assemblies 64 can be configured to divide the flow of vent byproducts V between the path P1 and the path P2 differently.

In this example, the relief valve assembly 64 in the open position divides the flow between the first path P1 and the second path P2. The amount of the flow directed to the first path P1 and the second path P2 depends on, among other things, the open position of the relief valve assembly 64.

The flow diverters 60, here the relief valve assemblies 64, divide the flow of vent byproducts V between the first path P1 and the second path P1 differently. The division can depend on an amount of time the flow of vent byproducts V is contained within the manifold system 50 when communicating along the respective first path P1 to the battery pack vent 54 compared to an amount of time the flow of vent byproducts V is contained within the manifold system 50 when communicating along the respective second path P2. In other examples, even though the first path P1 is longer than the second path P2, the flow rate through the first path P1 may be faster and the time that the vent byproducts spend within the manifold system when traveling along the first path P1 or the second path P2 to the battery pack vent 54 is about the same. {0048{

As can be appreciated, an amount of time that the flow of vent byproducts V will be contained in the manifold system 50 when communicating along the first path P1 and the second path P1 from the battery module 20A (FIG. 3) is further apart than the amount of time that the flow of vent byproducts V will be contained in the manifold system 50 when communicating along the first path P1 and the second path P2 from the battery module 20B (FIG. 4). The flow diverter 60 associated with the battery module 20A is thus configured to direct a greater percent of the flow of vent byproducts V to the first path P1 to give the flow time to dissipate thermal energy prior to being discharged through the battery pack vent 54. The first path P1 from the battery module 20A is longer than the second path. The flow diverter 60 associated with the battery module 20B has a different open position that more evenly divides the flow of vent byproducts V between the first path P1 and the second path P2.

The example relief valve assemblies 64 are configured to direct a greater percent of the vent byproducts V along the first paths P1 than along the second paths P2. This can help to lower thermal energy in the flow of vent byproducts V discharged through the battery pack vent 54. The open positions of the relief valve assemblies 64, in this example, controls the percent of vent byproducts V directed along the first paths P1 and the percent of vent byproducts V directed along the second paths P2.

At least some of the relief valve assemblies 64 are configured to have different open positions at a given pressure. For example, a pressure of 5 kilopascals within the battery module 20A may cause the relief valve assembly 64A to move to an first open position, and a pressure of 5 kilopascals within the battery module 20B may cause the relief valve assembly 64B to move to a second open position that is different than the first open position.

In this example, the open position for the relief valve assembly 64 associated with the battery module 20A is a first open position that directs ninety percent of the flow of vent byproducts V into the manifold system 50 a first direction D1 to flow along the first path P1 from the battery module 20A, and the remaining ten percent of the flow of vent byproducts V into the manifold system 50 in a second direction D2 to flow along the second path P2. The open position for the relief valve assembly 64 associated with the battery module 20B is a second open position that directs fifty-five percent of the flow of vent byproducts V into the manifold system 50 in the first direction D1 to flow along the first path, and the remaining forty-five percent of the flow of vent byproducts V into the manifold system 50 in the second direction D2 to flow along the second path.

The example relief valve assemblies 64 are disc valves having a valve disc 68 that rotates from the closed position to the open position. A biasing member, such as a torsion spring 72, biases the valve disc 68 to the closed position and resists rotation of the valve disc 68 due to pressure increases within the module enclosure assembly 32 of the associated battery module 20. In this example, the torsion spring 72 for the relief valve assemblies 64 is selected, at least in part, based on its spring rate, and the open position for the relief valve assembly 64 is established by the spring rate. The percent of flow directed along the first path P1 and the percent of flow directed along the second path P2 is thus controlled by the spring rates of the torsion springs 72 in the example embodiment. The percent of flow directed along the first path P1 and the percent of flow directed along the second path P2 can be adjusted by varying a biasing force of the torsion spring 72.

The spring rate for the torsion spring 72 associated with the battery module 20A can be less than the spring rate for the torsion spring 72 associated with the battery module 20B. This ensures that the valve disc 68 associated with the battery module 20A opens further in response to a given pressure than the valve disc 68 associated with the battery module 20B.

In other examples, the flow diverter 60 could be provided by valves that open, but do not divert flow to the first path and the second path. Instead, downstream from the valve, a fixed diverter could be position to guide a desired percent of the flow of vent byproducts to the first path and a desired percent of the flow of vent byproducts V to the second path.

Features of the disclosed examples include dividing a flow of vent byproducts to flow to a battery pack vent along more than one path to, among other things, reduce thermal energy in the flow of vent byproducts prior to discharging the flow of vent byproducts through the battery pack vent.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method of venting a traction battery pack, comprising:
providing a manifold system that fluidly couples a plurality of battery modules to a battery pack vent, each of the battery modules having an associated cell stack, the manifold system configured to communicate vent byproducts discharged from each cell stack along a first path to the battery pack vent and further configured to communicate vent byproducts discharged from each cell stack along a second path to the battery pack vent;
when a cell stack is discharging a flow of vent byproducts, directing a first percent of the flow through the manifold system along the first path to a battery pack vent, and directing a second percent of the flow through the manifold system along the second path to the battery pack vent;
and
exhausting the first percent and the second percent through the battery pack vent.

2. The method of claim 1, further comprising moving a relief valve assembly from a closed position to an open position to permit the first percent of the flow of vent byproducts to move to the first path and the second percent of the flow of vent byproducts to move to the second path, the first percent and the second percent dependent on the open position of the relief valve assembly.

3. The method of claim 1, wherein the traction battery pack includes a plurality of flow diverters, each flow diverter within the plurality of flow diverters associated with one of the battery modules within the plurality of battery modules, each flow diverter dividing the flow of vent byproducts from the associated cell stack into the first percent and the second percent,
wherein the flow diverters within the plurality of flow diverters divide the flow of vent byproducts differently from each other depending on an amount of time the flow of vent byproducts is contained within the manifold system when communicating along the first path to the battery pack vent compared to an amount of time the flow of vent byproducts is contained within the manifold system when communicating along the second path.

4. The method of claim 3, wherein the first percent of the flow of vent byproducts is contained within the manifold system for a first amount of time when communicated to the battery pack vent along the first path, and the second percent of the flow of vent byproducts is contained within the manifold system for a second amount of time when communicated to the battery pack vent along the second path, the first amount of time more than the second amount of time.

5. The method of claim 4, wherein the first amount of time and the second amount of time associated with exhausting vent byproducts from a first cell stack through the battery pack vent are further apart than the first amount of time and the second amount of time associated with exhausting vent byproducts from a second cell stack through the battery pack vent,
wherein the flow diverter that is associated with second cell stack more evenly divides into the first percent and the second percent than the flow diverter that is associated with the first cell stack.

6. The method of claim 5, wherein the first path from a first module having the first cell stack to the battery pack vent is a longer path than the second path from the first module to the battery pack vent.

7. The method of claim 6, wherein the plurality of flow diverters are a plurality of relief valve assemblies that move to an open position to permit discharging of the flow of vent byproducts from associated cell stack into the manifold system.

8. The method of claim 7, wherein the relief valve assemblies within the plurality of relief valve assemblies each include a spring, and further comprising adjusting the first percent and the second percent for each of the relief valve assemblies varying a biasing force for the spring.

9. A traction battery venting system, comprising:
a battery pack vent;
a first battery module having a first cell stack;
a second battery module having a second cell stack;
a manifold system that fluidly couples the first and second battery modules to the battery pack vent;
a first diverter configured to divert vent byproducts discharged from the first cell stack into the manifold system, the first diverter directing a first percent of the vent byproducts discharged from the first cell stack into the manifold system to flow along a first path to the battery pack vent, the first diverter directing a second percent of the vent byproducts discharged from the first cell stack into the manifold system to flow along a different, second path to the battery pack vent; and
a second diverter configured to divert vent byproducts discharged from the second cell stack into the manifold system, the second diverter directing a first percent of the vent byproducts discharged from the second cell stack into the manifold system to flow along the first path to the battery pack vent, the second diverter directing a second percent of the vent byproducts discharged from the second cell stack into the manifold system to flow along a different, second path to the battery pack vent.

10. The traction battery venting system of claim 9, wherein the first diverter is configured to direct more flow to the first path than to the second path.

11. The traction battery venting system of claim 10, wherein the first diverter is configured to direct more flow to the first path than the second diverter.

12. The traction battery venting system of claim 9, wherein first diverter is a first valve assembly having a first spring and the second diverter is a second valve assembly having a second spring, wherein a spring rate of the first spring is different than a spring rate of the second spring to make an open position of the first valve assembly different that an open position of the second valve assembly.

13. A traction battery venting system, comprising:
a plurality of battery modules each having at least one cell stack;
a battery pack vent; and
a manifold system that fluidly couples the battery modules to the battery pack vent, the manifold system configured to communicate a first percent of vent byproducts discharged from one of the cell stacks to the battery pack vent along a first path and to communicate a second percent of the vent byproducts discharged from the one of the cell stacks to the battery pack vent along a second path, the first path longer than the second path.

14. The traction battery venting system of claim 13, further comprising a diverter system having a plurality of diverters, each diverter within the plurality of diverters associated with one of the cell stacks within the plurality of cell stacks, each diverter within the plurality of diverters configured to direct more flow of the vent byproducts to the first path than the second path.

15. The traction battery venting system of claim 14, wherein the plurality of diverters comprise a plurality of relief valve assemblies that transition to an open position in response to a pressure differential.

16. The traction battery venting system of claim 15, wherein the plurality of relief valve assemblies each include a biasing member having a biasing force that controls the open position, wherein the biasing force among the plurality of relief valve assemblies is varied to cause some of the relief valve assemblies to direct more flow to the first path when in an open position that other relief valve assemblies in the open position.

17. The traction battery venting system of claim 15, wherein the relief valve assemblies are configured to open to permit the vent byproducts to move from the respective cell stacks to the manifold system, and the relief valve assemblies are configured to open different amounts to direct more flow of the vent byproducts to the first path.

18. The traction battery venting system of claim 13, wherein the manifold system circumscribes the plurality of battery modules.

19. The traction battery venting system of claim 13, wherein each of the cell stacks within the plurality of cell stacks is held within a module enclosure assembly.
